(19) United States
(12) Patent Application Publication
(10) Pub. No.: US 2002/0180764 A1
(43) Pub. Date: Dec. 5, 2002

(54) Method and system for digital image management

(76) Inventors: John Gilbert, Austin, TX (US); Dave Hawkins, Austin, TX (US)

Correspondence Address: Steven R. Greenfield, Esq., Jenkens & Gilchrist, P.C., 1445 Ross Avenue, Suite 3200, Dallas, TX, 75202-2799, US

(21) Appl. No.: 09/872,616

(22) Filed: Jun. 1, 2001

(51) Int. Cl. G09G 5/00

(52) U.S. Cl. 345/660

(57) ABSTRACT

Method and system for converting a plurality of digital images having different attributes to a common, selected/preset set of attributes, and for transferring them to a centralized storage unit are disclosed. Initially, the source locations of the digital images are identified. Next, the desired image attributes such as size, aspect ratio, color depth, and compression format for the digital images are selected. The digital images are then converted from their original attributes to the selected/preset attributes. The converted images are thereafter uploaded to the centralized storage unit where they may be stored and subsequently downloaded to one or more different users.

### BACKGROUND OF THE INVENTION

1. Field of the Invention

The present invention is related to digital images and, more particularly, to a method and system for managing such images.

2. Description of the Related Art

Recent advances in electronic imaging equipment and data compression technology have made it possible to capture and store pictures, photographs, and other graphical reproductions (hereinafter, “images”) in a convenient electronic format. With digital cameras, for example, a user simply aims and clicks, and the desired image is instantly captured and immediately available for viewing with no chemical processing involved. Similarly, optical scanners convert cumbersome hard copies of images into digitized soft copies for easy storage and subsequent access. These digitized and electronically stored images may thereafter be viewed and edited using an appropriate one of several presently available software imaging applications.

Every digital image has certain attributes or properties that define the image and, hence, the manner in which the image is stored and accessed. These image attributes may be different for each digital image depending, in part, on the type of imaging equipment and software used to create the image. For example, the size of an image can range from 320×240 up to 1024×768 pixels or higher. Similarly, the color depth of a digital image can range from 256 to over a million different shades of color. Also, a number of different data compression schemes (JPG, GIF, TIF, BMP, etc.) can be used to electronically store the images.

The digital images, coupled with the tremendous popularity of the Internet, have given rise to a host of on-line businesses and commercial ventures referred to generally as E-commerce. One particular application of E-commerce where digital images are often used is on-line shopping, otherwise known as the E-marketplace. Such E-marketplace applications often employ searchable on-line electronic archives or databases to store information on the products that are being offered on-line. The data contained in these databases can include text as well as the digital images discussed above and often a combination of both. The data may be presented in an organized and structured format such as in a product information sheet, an example of which is shown in FIG. 1. As can be seen, the product information sheet 10 includes a text description 12 of the product along with a digital image 14 thereof for easy perusal by an online shopper.

To facilitate searching of the on-line database, the data stored therein are usually arranged in a standardized format. For example, in the case of the product information sheet 10, the text description usually contains certain specific items of information, and the digital images usually have a common set of attributes, e.g., a common size, color depth, and compression format. Such a standardized format also provides a consistent look and feel to the data stored in the database. However, because the digital images often come from or are provided by many different, uncoordinated sources, they rarely all have the same specific image attributes. For example, the images from one source may be 640×480 pixels in size while another source may provide images that are 1024×768 pixels. Accordingly, the disparate attributes of these images frequently have to be manually converted into some selected standard format before the images are transferred to the database.

Several presently available software imaging applications allow a user to modify or edit the attributes of a digital image. For example, Adobe Photoshop (TM) and Corel Draw (TM) are two such applications that allow the digital images to be resized and converted from one format to another. However, the level of technical knowledge required to install and use these software applications often place them beyond the average, non-technical user's usage. Moreover, these software applications usually require each digital image to be manually converted one image at a time. Such a manual conversion process can be extremely tedious and time consuming, even for highly technical users. In addition, a separate file transfer application is often needed to upload or otherwise transfer the images from the imaging software application to the database after conversion, thereby further increasing the amount of technical knowledge and work imposed upon the user.

Therefore, based on the foregoing, it is desirable to be able to provide a method and system to automate the image conversion and upload process. More specifically, it is desirable to be able to provide a way to convert multiple digital images having different attributes to a selected, preset set of attributes, and to transfer the converted images to their intended destination.

### SUMMARY OF THE INVENTION

The present invention is directed to a method and system for converting a plurality of digital images having different attributes to a common, selected/preset set of attributes, and for transferring them to a centralized storage unit. Initially, the source locations of the digital images are identified. Next, the desired image attributes such as size, aspect ratio, color depth, and compression format for the digital images are selected. The digital images are then converted from their original attributes to the selected/preset attributes. The converted images are thereafter uploaded to a centralized storage unit where they may be stored and subsequently downloaded to one or more different users.

In one aspect, the invention is related to a method of standardizing a plurality of digital images. The method comprises accessing the digital images, determining an attribute for each one of the digital images, converting each determined attribute to a predefined attribute, and transferring the digital images to a predetermined storage location.

In another aspect, the invention is related to a system for standardizing a plurality of digital images. The system comprises a network interface unit, a central processing unit coupled to the network interface unit, and a storage unit coupled to the central processing unit. The storage unit has a program storage portion that stores a program having a data acquisition module for accessing the digital images, a data processing module for determining an attribute for each one of the digital images and for converting each determined attribute to a predefined attribute, and a data transfer module for transferring the digital images to a predetermined storage location.

In yet another aspect, the invention is related to a method of managing multiple digital images that may be related to each other or unrelated to each other. The method comprises the steps of selecting a source of the digital images, verifying a security authorization of the source, accessing the digital images, associating related images to each other, determining a size, aspect ratio, color depth, and compression format for each one (all or subsets) of the digital images, converting each image to the determined size, aspect ratio, color depth, and compression format to a predefined size, color depth, aspect ratio, and compression format, uploading the digital images to a storage location, storing the uploaded digital images in a storage space allocated to the source in the storage location, downloading the stored digital images to at least one client, and compiling a list of the digital images downloaded to the at least one client.

### BRIEF DESCRIPTION OF THE DRAWINGS

A more complete understanding of the method and system of the present invention may be had by reference to the following detailed description when taken in conjunction with the accompanying drawings wherein:

FIG. 1 illustrates a typical product information sheet;

FIG. 2 illustrates a system according to an embodiment of the present invention;

FIG. 3 illustrates a block diagram of the functional components of a server according to an embodiment of the present invention;

FIG. 4 illustrates a digital image management program according to an embodiment of the present invention;

FIGS. 5A-5D illustrate an exemplary user interface according to an embodiment of the present invention;

FIG. 6 illustrates a data acquisition module and data processing module according to an embodiment of the present invention;

FIG. 7 illustrates a security module, a data transfer module, and a data storage module according to an embodiment of the present invention;

FIG. 8 illustrates the data storage module and a output manager module according to an embodiment of the present invention; and

FIG. 9 illustrates a method according to an embodiment of the present invention.

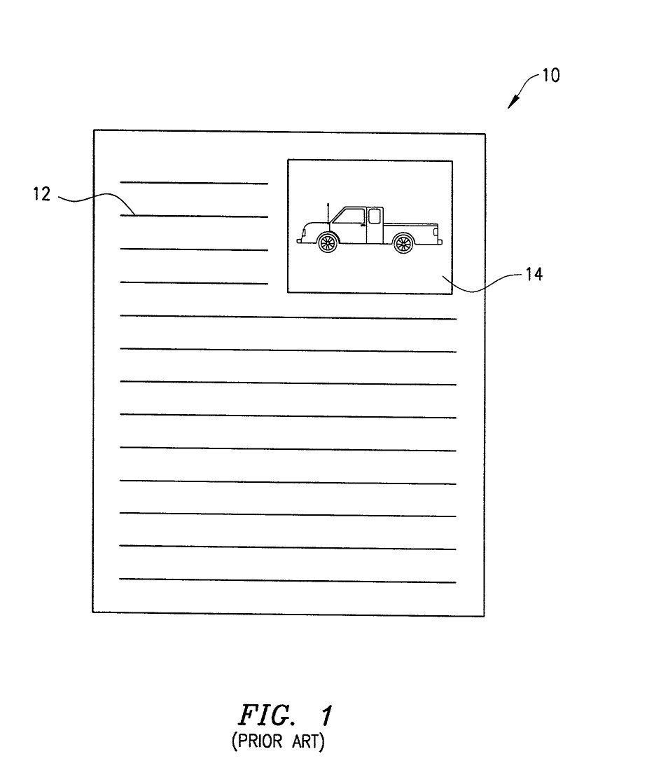

### DETAILED DESCRIPTION OF THE PREFERRED EXEMPLARY EMBODIMENTS OF PRESENT INVENTION

Exemplary embodiments of the present invention convert multiple digital images, having different attributes, to a common, selected or preset set of attributes. The exemplary embodiments may load or otherwise access the images from one or more data sources, resize and reformat the images, and then transfer them to their intended location. The exemplary embodiments of the present invention may perform these functions with minimal user or manual interaction, thereby making the image conversion and transfer process much easier and less time consuming than heretofore available. An exemplary embodiment may be adapted to provide a more standardized image output which was unavailable from prior manual manipulation of the images. Furthermore, an embodiment of the present invention may load and manage multiple images related to a single inventory or sales item.

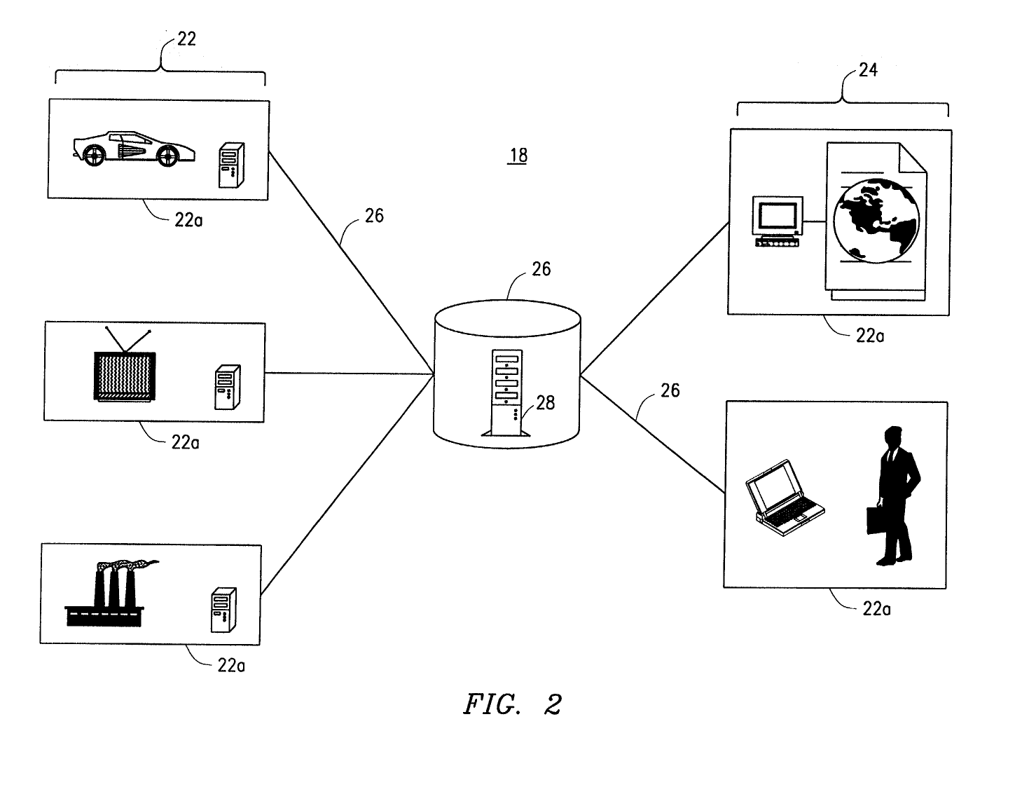

Referring now to FIG. 2, a digital image management system 18 according to an exemplary embodiment of the present invention is shown. The system 18 includes a centralized library or archive 20 selectively connected to one or more data sources shown generally at 22, and also selectively connected to one or more clients shown generally at 24. The data sources 22 may be any provider of data or information for any goods or services that may be obtained by a user. Examples of the data sources 22 may include, but are not limited to, an automobile dealership 22a that can provide information regarding its cars, a retailer of consumer electronics 22b that can provide information on its appliances, and a manufacturing facility 22c providing information about its articles of manufacture. Similarly, the clients 24 may be any user who can use the information provided by the data sources 22. The clients 24 may include, for example, a Web site 24a that acts as an on-line repository of the information provided, or a business 24b that is a direct consumer of the information. Numerous other examples of data sources 22 and clients 24 exist, including real estate agencies providing information on houses for sale to an on-line home buyer's's guide, an electronic parts manufacturer similarly providing data sheets to an on-line components distributor, etc.

Although only a few data sources 22 and clients 24 are shown connected to the archive 20, the invention is not so limited and may be expanded as needed to accommodate the required numbers thereof. A plurality of exchangeable access lines 26 connect the data sources 22 and clients 24 to the archive 20.

One exemplary implementation of the system shown in FIG. 2 is in an E-marketplace type application. In an E-marketplace implementation, the data sources 22 may be a retailer or reseller of one or more goods or services, and the clients 24 may be an operator of a searchable on-line database for the goods or services. The data sources 22 provide information regarding the goods or services including any digital images thereof to the clients 24, and the clients 24 make this information available to consumers via the searchable on-line databases. A consumer can then access the database operated by one of the clients 24 to find information for a particular good or service including a description of the product, pricing, and availability information. The consumer may thereafter place an order for the product through the clients 24, or purchase the product directly from the data sources 22. The data sources 22 often have an agreement with the clients 24 whereby a predetermined fee or commission is paid to the clients 24 for each order or purchase expedited thereby.

Other possible implementations of the system 18 shown in FIG. 2 include a service for the provision of news, product catalogs, technical reference materials, or other types of information by the data sources 22 to the clients 24. Accordingly, the terms “goods,” “services,” and “products” as used herein should not be limited to any one particular meaning, but may include any type of goods, services, or products for which information may be collected.

To facilitate the information collecting and distributing process, the archive 20 may be used in one embodiment as a centralized repository for the information. Thus, instead of a scenario where each one of the data sources 22 separately and individually sends information directly to each one of the clients 24, the information can be uploaded to and centrally stored by the archive 20. The archive 20 allocates storage space to each of the data sources 22 and is generally responsible for the managerial and administrative duties associated with storing the information. The information can then be downloaded from the archive 20 to the clients 24 according to some prearranged agreement there between. Subsequent updates in the information can be collected and distributed in a similar manner. Under this arrangement, instead of multiple file transfers taking place, the information may be advantageously uploaded and downloaded one time to and from one location, namely, the archive 20.

The archive 20 may include one or more server computers 28, each having one or more large capacity hard drives, CD-ROMs, magnetic tape drives, or a combination thereof (hereinafter, “storage unit”), that can serve as a repository of data. In a preferred embodiment, the server 28 is a type of server referred to as a Web server that is capable of hosting a Web site thereon. Access to the Web site hosted on the server 28 may be gained by using any one of several commercially available Web browsers such as Internet Explorer (TM) from Microsoft Corp. or Netscape Navigator (TM) from Netscape Corp., or some modified version thereof. Thus, in order to make use of the Web site, it is contemplated that one of these Web browsers will be installed on every one of the data sources 22.

The data sources 22 may include therein any electronic device that is capable of uploading information including digital images to the archive 20. In a preferred embodiment, each one of the data sources 22 is capable of supporting a Web browser for accessing the Web site mentioned above. Examples of suitable types of electronic devices include a server, desktop computer, portable computer, and personal digital assistant. These electronic devices usually have one or more I/O portals such as a floppy disk drive, CD-ROM, or other data I/O connections for inputting the digital images. Alternatively, the digital images may be scanned into the data sources 22 by using an optical scanner, or made available to the data source 22 by some other means. The data sources 22 may thereafter transfer the images to the archive 20 where they can be uploaded to the clients 24.

The clients 24 may include therein any electronic device that can receive and store the digital images downloaded from the archive 20. In an exemplary embodiment, the clients 24 include one or more servers that support the searchable online database mentioned previously. In a preferred embodiment, the servers of the clients 24 also includes a Web server, and the searchable database is implemented in the form of a Web site. Users may access the Web site using any one of the available Web browsers to find, for example, information on a particular product.

The access lines 26 that connect the archive 20 to the data sources 22 and the clients 24 may be any type of line that can connect the archive 20 to a local or remote location. Examples of suitable access lines 26 include standard public telephone lines, dedicated high-speed subscriber lines (e.g., ISDN lines), and wireless transmission lines. The details of how to establish a connection between the archive 20, the data sources 22, and the clients 24 are generally well known to those of ordinary skill in the art and will not be discussed here.

FIG. 3 illustrates some of the functional components of the server 28 of the archive 20. Specifically, the server 28 includes a central processing unit 30, a network interface 32, a data storage unit 34, a program storage unit 36, and a display unit 38, all interconnected as shown. The central processing unit 30 is primarily responsible for executing the various software programs that may be running on the server 28. The network interface 32 is responsible for connecting the server 28 to the on-line domain in general and specifically to the Internet. The data storage unit 34 provides long-term storage for any data stored on the server 28 such as the digital images from the data sources 22. The program storage unit 36 stores the various software programs and operating system running on the server 28. Although in this embodiment the data storage unit 34 and program storage unit 36 are shown as separate units, they may easily be combined into a single storage unit in other embodiments and thereafter partitioned into a data portion and a program portion. Finally, the display unit 38 is responsible for graphically displaying any visual output from the central processing unit 30.

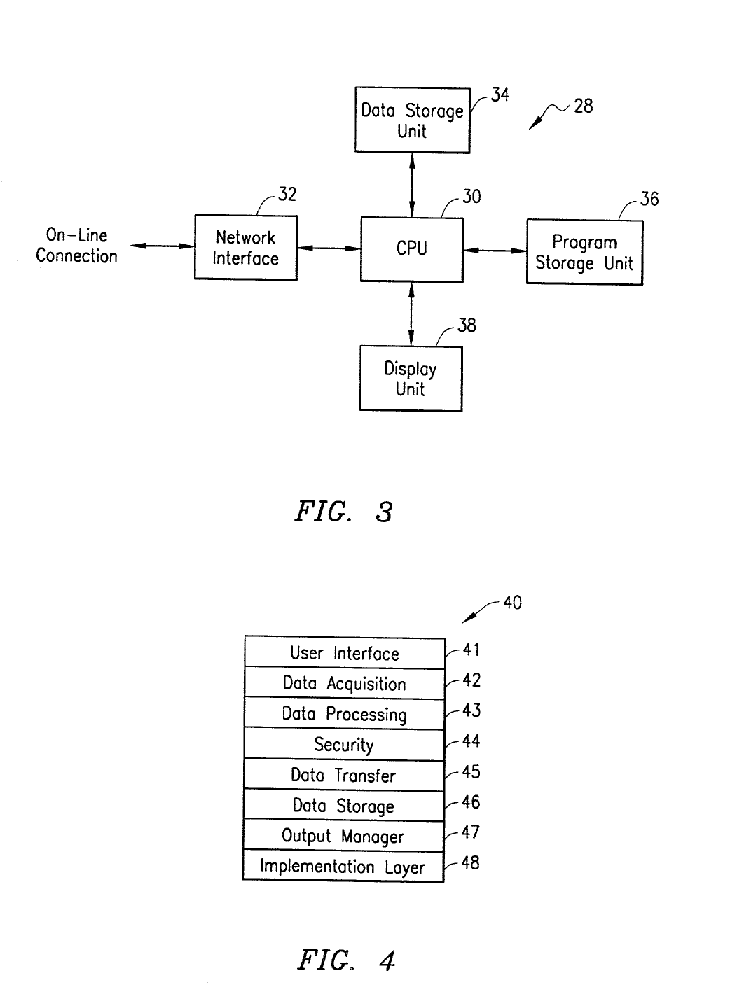

One of the software programs stored by the program storage unit 36 of the server 28 is a digital image management program, illustrated in FIG. 4. As mentioned previously, the digital images from the data sources 22 rarely all have the same image attributes because they can come from many different, uncoordinated data sources. Accordingly, these images should be standardized to a common, selected or preset set of image attributes before they are sent to the clients 24. The digital image management program 40 is capable of converting the digital images into a standardized digital format and transferring them to their intended destination. Once converted the standardized digital images will each have similar dimensions, pixel size, contrast, hue, aspect ratio, color depth, compression format, etc.

In a preferred embodiment, the digital image management program 40 is a Web-based application that can be executed in a Web browser environment. In this embodiment, a Web browser running at one of the data sources 22 may be used to access the Web site hosted on the server 28 by opening the URL therefor. Once the Web site has been accessed, the digital image management program 40 may be activated by clicking on the appropriate link therein. The digital image management program 40 will thereafter execute within the Web browser running on one of the data sources 22. Such an arrangement advantageously eliminates the need to install the entire digital image management program 40 at each one of the data sources 22. In addition, because the digital image management program 40 is executing within a separate Web browser at each one of the data sources 22, multiple instances of the program can be executed at the same time. Following is a more detailed description of the operation of the digital image management program 40.

The functional components of the digital image management program 40 generally include a user interface module 41, a data acquisition module 42, a data processing module 43, a security module 44, a data transfer module 45, a data storage module 46, and an output manager module 47. An ActiveX layer or other suitable implementation layer 48 allows the digital image management program 40 to be executed in the Web browser environment.

Upon clicking on the appropriate link, the user interface module 41 deploys a graphical user interface to facilitate interaction between the user and the digital image management program 40. More specifically, the graphical user interface serves as a top level interface between the user and the various modules of the digital image management program 40 to help the user navigate through the many functions of the digital image management program 40. Such an interface allows the user to select, convert, and upload the digital images without having to know or learn the technical details of the various modules that are operating behind the scenes.

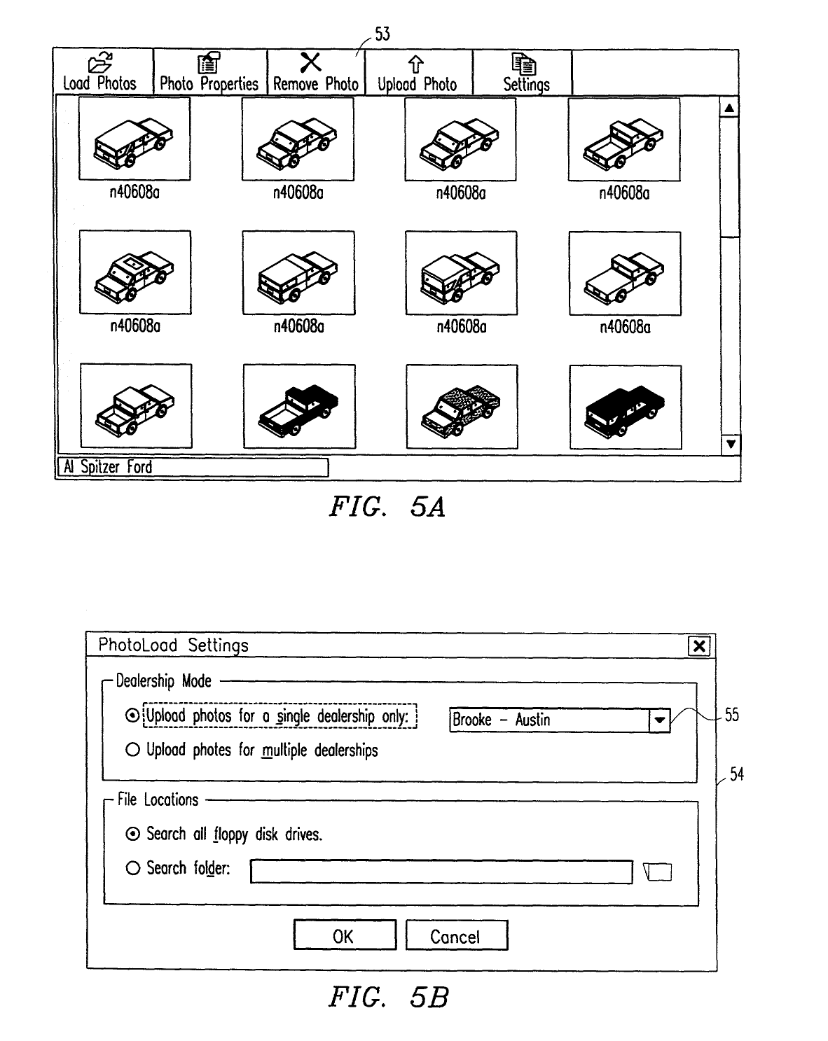

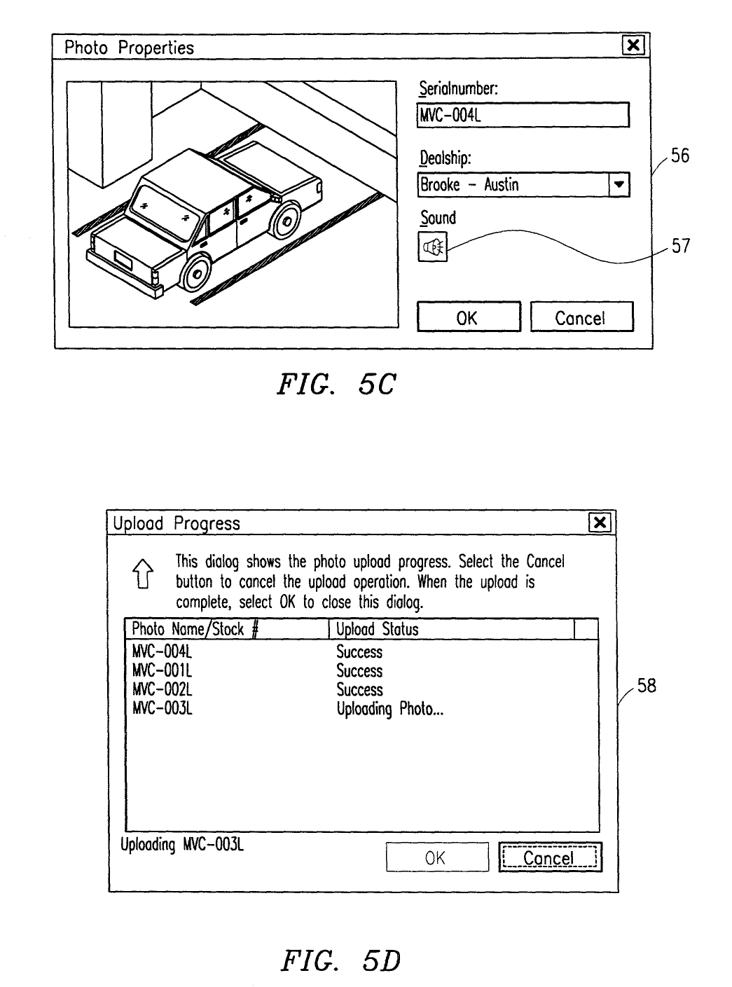

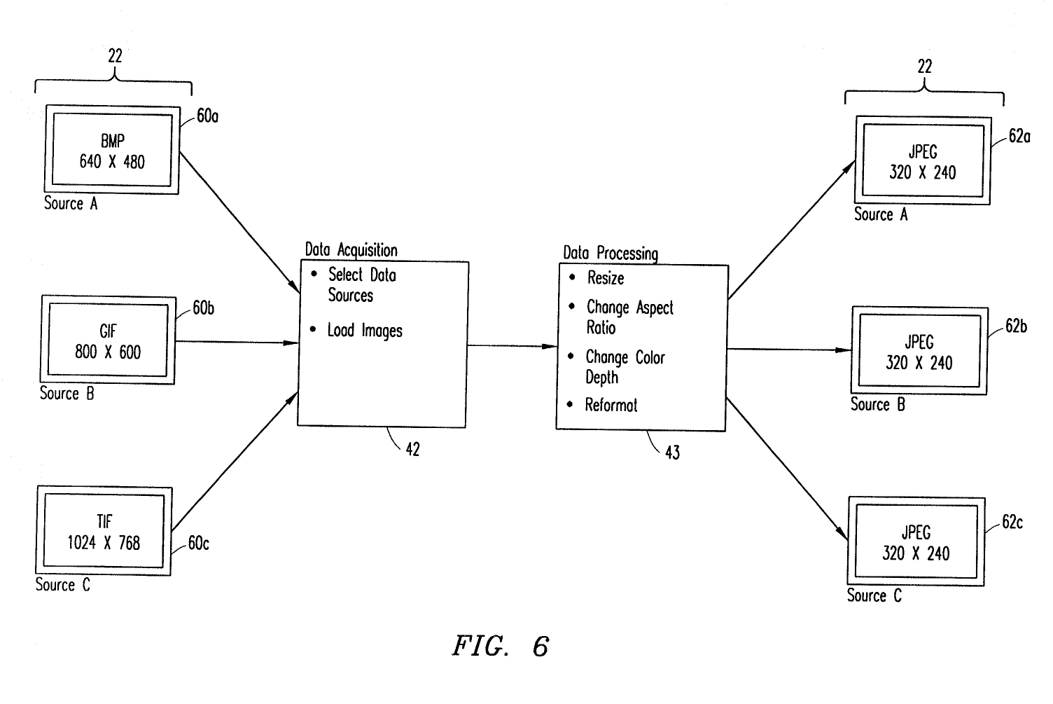

One example of a graphical user interface is shown generally at 50 in FIG. 5A. As can be seen, a first screen 52 of the graphical user interface 50 has several exemplary tabs 53 displayed along the upper portion thereof to allow the user to select the functions to be performed by the digital image management program 40. Such functions can include loading photos, setting photo properties, removing photos, and uploading photos to the archive 20. It is understood that for the purposes of this document photos and images can be the same thing. Also displayed are thumbnails for each of the digital images that have been selected to be uploaded to the archive 20 from one of the data sources 22.

An embodiment of the present invention allows a user to load and the system to manage multiple images related to a single inventory part or sales item. For example, a vehicle or house for sale may have multiple views associated with it (e.g., front, rear, interior, etc.) while a part or item for an airplane may have a photographic style image, a schematic and a FAA certificate associated with it.

FIG. 5B illustrates a second screen 54 of the exemplary graphical user interface 50. The purpose of this screen is to allow the user to select one or more of the data sources 22. In a preferred embodiment, the names and geographical locations of the data sources 22 are already entered into the digital image management program 40 and may be selected from a drop-down menu 55. The user can also specify the exact location (e.g., a floppy disk, CD-ROM, memory card, folder, etc.) where the digital image files to be uploaded may be found on the local computer. Depending on the software and/or digital camera being used, the images may be stored/retrieved from a floppy drive, memory card, cd rom, folder, or output directly from the camera, scanner or other imaging device.

Once selected, the digital images from the selected data sources 22 will then be displayed as thumbnails as shown by the first screen 52. It is noted that in a preferred embodiment the screen 54 is substantially the only screen that a user may have to interact with. All other settings, such as image resolution, compression format, color depth, etc. may be set on the “server side” by system administrators. The dealership mode screen 52 allows photos or images to be entered for a single location (as depicted in FIG. 5B) or for multiple locations. The multiple locations setting is used if a group of, for example, auto dealerships hire a single person to take inventory photos for the various dealership locations. The screen 52, in a multiple dealership mode, the user would be prompted user for the actual dealership inventory that each photo is associated with, rather than defaulting to a single retail location.

Double-clicking on any of the thumbnail images displayed by the first screen 52 will bring up a third screen 56, shown in FIG. 5C, that allows a user to individually label or name the double-clicked image. The image names or labels are typically chosen according to a unique identification number of the associated product such as a stock code or vehicle identification number. In addition, many digital cameras now feature a sound recorder whereby a sound clip may be recorded with the captured image. Where such sound recordings are available, the sound clip may be attached to the image by clicking on, for example, a sound button 57 and following the instructions arising therefrom.

When the selected images are labeled and deemed ready to be uploaded to the archive 20, the user simply selects the exemplary “upload” tab from the first screen 52, and the images are uploaded or transferred to the archive 20. Thereupon, a fourth screen 58 of the user graphical interface 50 is deployed, as shown in FIG. 5D, to allow the progress of the uploading images to be monitored. This automatic file transfer feature advantageously eliminates the need to install and execute a separate file transfer application in order to upload the digital images.

It should be noted that, although a few exemplary screens of the graphical user interface 50 were described, the invention should not be limited thereto and other screens may be added as needed to enhance the interactivity and functionality of the user graphical interface 50.

Turning now to FIG. 6, the operation of the data acquisition module 42 and the data processing module 43 of the digital image management program 40 is shown. The digital images 60a-60c represent one or more images of the same or different goods or services provided by the data sources A, B, and C 22, respectively. As can be seen, each of the digital images 60a, 60b, and 60c from the data sources A, B, and C has a different set of attributes. For example, the digital images 60a from source A are 640×480 BMP files, the digital images 60b from source B are 800×600 GIF files, while the digital images 60c from source C are 1024×768 TIF files. These digital images 60a-60c, or a subset thereof, can be selected and subsequently accessed by or otherwise loaded into the digital image management program 40 through the operation of the data acquisition module 42.

Once the digital images are selected and loaded, they are standardized according to some selected or preset set of attributes by operation of the data processing module 43. In some embodiments, the standard set of attributes may be preset in the digital image management program 40 by a system administrator of the server 28 and may not be changed by the user. In other embodiments, there are no preset attributes; rather the attributes may be selected by the user as needed through the graphical user interface 50. In a preferred embodiment, the attributes may be preset by the system administrator of the server 28 as a default set of attributes, but may thereafter be overridden by an authorized user as needed.

In operation, the data processing module 43 determines the initial attributes of the digital images 60a-60c by, for example, obtaining this information from the appropriate header fields of the digital image files. The data processing module 43 thereafter converts the digital images 60a-60c to the selected or preset attributes. More specifically, the data processing module 43 performs a resizing, reformatting, and changing of the aspect ratio and the color depth of the digital images 60a-60c as needed to match that of the selected or preset attributes. As can be seen, the digital images 62a-62c that result from the operation of the data processing module 43 now have a common set of attributes, e.g., 320×240 pixels and JPG format.

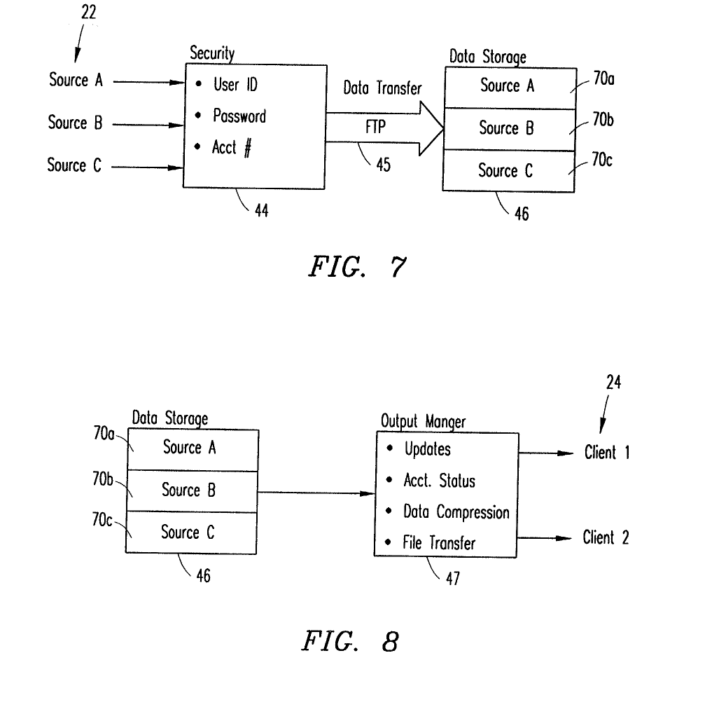

FIG. 7 illustrates the operation of the security module 44, data transfer module 45, and data storage module 46. The security module 44 is responsible for preventing unauthorized access to the digital image management program 40. Upon activation of the digital image management program 40 (e.g., by clicking on the appropriate link), the security module 41 attempts to verify the security authorization of the data sources 22 shown here as sources A-C. The security module 44 may request, for example, an account number, user ID, a password, or some combination thereof in order to verify the security authorization of the data sources 22. Such information is typically assigned by the security module 44 at the time an account is set up with the archive 20 for each one of the data sources 22. If the given information is verified as correct, execution of the digital image management program 40 is allowed to continue. Otherwise, after a predetermined number of unsuccessful attempts, the security module 43 stops execution of the digital image management program 40 and provides an appropriate notice of the error to the user.

After verifying the security authorization of the data sources 22, the digital images provided thereby are uploaded or otherwise transferred to the data storage module 46 by operation of the data transfer module 45. In a preferred embodiment, the digital images provided by the data sources 22 have already been converted by the data processing module 43 (see FIG. 6) before they are transferred. This arrangement has an advantage in that the converted digital images are usually smaller in size and require less time to transfer relative to the original digital images.

The data transfer module 45 uses one of several presently available techniques to transfer the digital images. In one embodiment, the data transfer module 45 uses FTP (File Transfer Protocol) to transfer the digital images. However, in other embodiments, other suitable file transfer techniques may certainly be used without departing from the scope of the invention.

At the other end of the file transfer process, the transferred digital images are received and stored by operation of the data storage module 46. The data storage module 46 operates behind the scenes in conjunction with the security module 44 to allocate storage space in the data storage unit of the archive 20 (see FIG. 3). Storage spaces are allotted only to those data sources 22 for which security authorization has been verified. For example, sources A-C each have allocated storage spaces 70a-70c for storing their respective transferred digital image files as shown. Thus, by virtue of the operation of the security module 44 and the storage module 46, storage space for each one of the data sources A-C can be allotted without additional user interaction.

FIG. 8 illustrates the operation of the output manager module 47. After the digital image files have been stored by the data storage module 46 in their respective allocated storage spaces 70a-70c, the output manager module 47 performs various managerial and administrative tasks pertaining to the stored digital images. For example, the output manager module 47 compiles a report listing all the digital images currently stored in the data storage unit. The report lists the digital images according to the names of the data sources 22 and is made available to both the data sources 22 and the clients 24. The data sources 22 can thereafter review the report to determine whether there are any incorrect or missing digital images. Likewise, the clients 24 may also check to see if any digital images are incorrect or missing. In addition, the output manager module 47 generates an account status report for each one of the clients 24 detailing the current account status.

The output manager module 47 also operates to download or otherwise transfer the stored digital images to the clients 24 in accordance with known file transfer techniques (e.g., FTP). In some embodiments, the digital images may be transferred as a batch transfer wherein several digital images are grouped together and transferred at the same time. In this case, it may be desirable to perform some type of data compression in order to reduce the overall size of the files being transferred. In other embodiments, the digital images may be transferred one at a time on an individual basis.

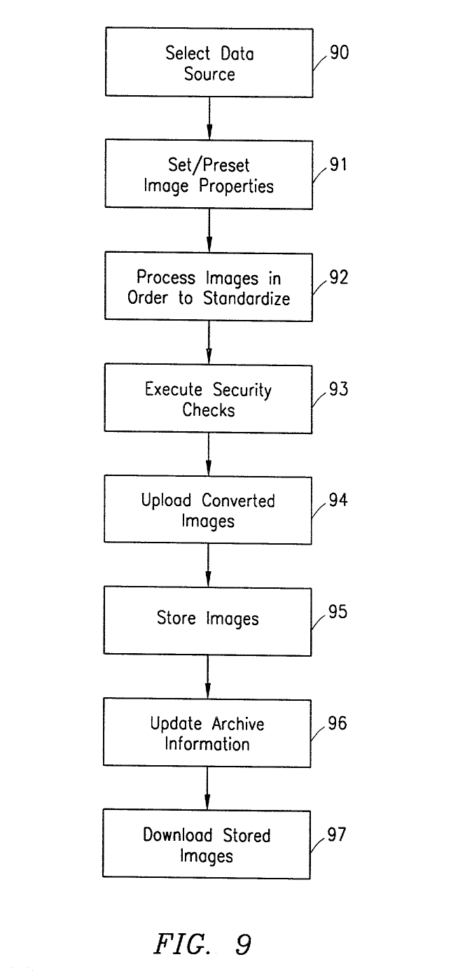

FIG. 9 illustrates an exemplary method of managing multiple digital images according to an embodiment of the present invention. Starting at step 90, the data sources from which the digital images may be obtained are selected. A standard set of image attributes is preset and/or selected at step 91. At step 92, the digital images from the selected data sources are processed and converted to the standard set of attributes. A security check is performed at step 93 to make sure each one of the selected data sources have the proper security authorization. At step 94, the converted images are uploaded to a centralized archive having a data storage unit. The uploaded images are thereafter stored in the storage spaces allocated to each one of the authorized data sources at step 95. At step 96, the contents of the archive are updated and a report is made available to the data sources and the clients. Account status reports are also generated and made available to the clients at this time. Finally, at step 97, the stored images are downloaded to the clients.

Although several embodiments of the method and system of the present invention have been illustrated in the accompanying drawings and described in the foregoing detailed description, it should be understood that the invention is not limited to the embodiments disclosed, but is capable of numerous rearrangements, modifications, and substitutions without departing from the spirit of the invention as set forth and defined by the following claims.

What is claimed is:

1. A method of standardizing a plurality of digital images, said method comprising the steps of:
accessing said digital images;
determining whether any of said digital images are related to other ones of said digital images;
determining an attribute for each one of said digital images;
converting each determined attribute to a predefined attribute; and
transferring said digital images to a predetermined storage location.

2. The method according to claim 1, wherein said steps of accessing, determining, and converting are performed in a Web browser environment.

3. The method according to claim 1, wherein said attribute includes an image size.

4. The method according to claim 1, wherein said attribute includes an image aspect ratio.

5. The method according to claim 1, wherein said attribute includes an image color depth.

6. The method according to claim 1, wherein said attribute includes an image compression format.

7. The method according to claim 1, wherein said digital images are transferred using a File Transfer Protocol.

8. The method according to claim 1, comprising selecting a source of said digital images, and verifying a security authorization of said source.

9. The method according to claim 8, wherein said predetermined location includes a data storage unit.

10. The method according to claim 9, said data storage unit includes storage space allocated to said source, and said transferred digital images are stored in said allocated storage space.

11. The method according to claim 10, further comprising transferring said stored digital images to at least one client.

12. The method according to claim 11, further comprising generating a list of said stored digital images for said source and said at least one client.

13. A system for standardizing a plurality of digital images, said system comprising:
a network interface unit;
a central processing unit coupled to said network interface unit; and
a storage unit coupled to said central processing unit, said storage unit having a program storage portion, said program storage portion storing a program having:
a data acquisition module for accessing said digital images;
a data processing module for determining an attribute for each one of said digital images and for converting each determined attribute to a predefined attribute and for setting relational attribute to keep predetermined digital images related to one another; and
a data transfer module for transferring said digital images to a predetermined storage location.

14. The system according to claim 13, wherein said program stored in said program storage portion is a Web based application.

15. The system according to claim 13, wherein said attribute includes an image size.

16. The system according to claim 13, wherein said attribute includes an image aspect ratio.

17. The system according to claim 13, wherein said attribute includes an image color depth.

18. The system according to claim 13, wherein said attribute includes an image compression format.

19. The system according to claim 13, wherein said data transfer module transfers said digital images using a File Transfer Protocol.

20. The system according to claim 13, wherein said data acquisition module further selects a source of said digital images.

21. The system according to claim 20, further comprising a security module for verifying a security authorization of said source.

22. The system according to claim 21, wherein said predetermined storage location includes a data storage portion of said storage unit.

23. The system according to claim 22, wherein said data storage portion includes a storage space allocated to said source.

24. The system according to claim 23, further comprising an output manager module for transferring said digital images to at least one client.

25. The system according to claim 24, wherein said output manager module further generates a list of said stored digital images for said source and said at least one client.

26. A method of managing multiple digital images, said method comprising;
selecting a source of said digital images;
verifying a security authorization of said source;
accessing said digital images;
determining a size, aspect ratio, color depth, and compression format for each one of said digital images;
converting each determined size, aspect ratio, color depth, and compression format to a predefined size, aspect ratio, color depth, and compression format;
uploading said digital images to a storage location;
storing said uploaded digital images in a storage space allocated to said source in said storage location;
downloading said stored digital images to at least one client; and
compiling a list of said stored digital images for said source and said at least one client.
